(19) United States
(12) Patent Application Publication
(10) Pub. No.: US 2008/0286437 A1
(43) Pub. Date: Nov. 20, 2008

(54) Method for the Production of Sausages

(76) Inventors: Peter Eisner, Freising (DE); Klaus Muller, Freising (DE); Christian Zacherl, Freising (DE); Josef Pointner, Mindelheim (DE)

Correspondence Address: BARNES & THORNBURG LLP, 750-17TH STREET NW, SUITE 900, WASHINGTON, DC, 20006-4675, US

(21) Appl. No.: 11/908,049

(22) PCT Filed: Feb. 18, 2006
(86) PCT No.: PCT/DE06/00307

§ 371 Date: Jan. 25, 2008

(30) Foreign Application Priority Data
Mar. 7, 2005 (DE) 10 2005 010 836.9
Jun. 9, 2005 (DE) 10 2005 026 752.1

(51) Int. Cl. A22C 11/00; A23L 1/317

(52) U.S. Cl. 426/646; 452/30

(57) ABSTRACT

A sausage product and a method for producing the sausage product, wherein the sausage product includes one or more of raw sausages, scalded sausages and cooked sausages.

### PRIOR ART

The present invention relates to a method for the production of sausages, such as raw sausages, scalded sausages (emulsion-type sausages), cooked sausages, or cooked meat spread, according to the preamble of claim 1, and to sausages according to the preamble of claim 29.

Sausages (sausage and sausage-like products) in the conventional sense are certain firm or spreadable mechanical mixtures of shredded meat, fat tissue and, depending on the type, in part even of offal, and in special products also of other parts of animal carcasses, using taste-bearing and/or technologically motivated ingredients.

According to the definition in the guidelines for meat and meat products, meat is defined as “all parts of slaughtered or killed warm-blooded animals intended for human consumption”. According to this definition, for example, bones and offal will also be covered by the term “meat”.

In the commercial production of sausages, “meat” is only skeletal muscle with attendant or embedded fat and connective tissue, and embedded lymphatic nodes, nerves, blood vessels and pigs' salivary glands. In some meat products, “meat” also includes a certain proportion of ingrown bone and cartilage, in the case of “pork” also the rind.

When pork is used for sausages, the following types of meat may be distinguished depending on the way it is cut up:

pig's head

pig's jowl

pig's neck

breast or thick rib,

rib chop,

loin chop,

filet steak,

belly of pork (spareribs and pork belly),

shoulder (ham),

ham or leg (rump, shank, and central part),

pickled knuckle of pork and

pigs trotters.

With the exception of the filet, sausages are made from all the above mentioned parts of the pig, wherein the fractions are mixed in different proportions. More or less fat is embedded in the muscle tissue depending on the part of the carcass used.

With sausages, generally raw sausages, scalded sausages and cooked sausages are distinguished. Sausages are marketed smoked or unsmoked, in casings or containers or even without casings.

“Raw sausages”, such as salami or cervelat are usually un-reddened sausages storable in an unrefrigerated state (above +10° C.) which are usually eaten raw, and which are spreadable or after maturing and attendant drying also firm. Sugar is added in an amount of not more than 2%.

“Cooked sausages”, such as liver sausage, are heat-treated sausages, primarily made of cooked ingredients. Raw ingredients only predominate if there is a large proportion of blood, liver and fat tissue. Cooked sausages are usually only firm to cut in a cooled-down state.

“Scalded sausages”, such as Frankfurters or “bologna-type” sausages (“Lyoner”), are sausages which have been heat treated by scalding, baking, frying or in any other way, wherein ground raw meat is completely or partially comminuted with fat, cooking salt and, if necessary, other technologically necessary salts, mostly with the addition of drinking water, and wherein the muscle protein has been more or less continuously coagulated during heat treatment, so that the products remain firm when they are reheated. The amount of drinking water used differs from one type of sausage to the other. As a proportion of the meat and fat, up to 10% blood plasma or blood serum is sometimes added instead of drinking water; the replacement of drinking water by 5% milk is restricted to unsmoked sausages intended for frying having a finely comminuted meat batter.

Well known scalded sausages contain about 50% meat, 25% fat and 25% water on average. The meat and lard is first ground in the grinder (mincer) and in most cases is then cutter processed to produce the so-called meat batter (meat mixture). A cutter comprises a rotating vessel (bowl), in which a plurality of knives rotate at very high speed. Herein, the ingredients are comminuted to such an extent, that a paste results, referred to as meat batter in the case of raw meat.

In the cutter, the proteins are partially dissolved and swollen by 1.5-2% cooking salt, while a preserving effect is achieved at the same time. In addition to spices, nitrite pickling salt and cutter additives are also added. After cutter processing, the meat batter is filled into gut, which is followed by smoking, if any, and then by that step from which it derives its name, namely scalding. The meat batter is treated with a core temperature at which the proteins of the muscle fibres coagulate forming a gel.

The consistency of a scalded sausage depends on its ability to bind water, which is therefore a critical factor in the production of scalded sausages besides fat emulsification and stabilisation and structure formation (jellification).

By adding fat to the cutter, an emulsion is created in the scalded sausage production. The hydrophobic protein sequences are added at the phase boundary and help in directing the proteins and partially fractioning the proteins. In the protein/water mixture surrounding the fat, hydrophile groups, highly water-soluble and cross-linkable proteins are enriched, which facilitate good jellification and high water binding in the subsequent scalding process.

If there is only a small amount of fat available during cutter processing, this fractioning process cannot happen. The result is that the jellification and water-binding processes are reduced in the protein/water mixture. The fat content in known scalded sausages, depending on the application and the recipe, is between 15 and 30 weight % in the finished product. With this fat content, a firm and resilient texture and pleasant taste can be achieved in the final sausage.

There is already a wide variety of scalded sausages available with a reduced fat content with respect to the above (fat content 5%-19%). They mostly contain poultry meat or more or less fat meat from a variety of beef or pork cuts. Due to the low fat content, the known low-fat products on the market usually have a dry, grainy character and do not have a fresh, meaty taste. The disadvantages in texture due to a lack of fat are therefore compensated in many sausage types by the addition of vegetable oils or oil-based fat substitutes. It has hitherto not been possible, however, to produce a low-fat scalded sausage with a pleasant texture.

Moreover, sausages often have a bad reputation with consumers due to the wide variety of organic fractions usually incorporated (muscle tissue, rind and skin, fat, connective tissue, parts of offal, lymphatic nodes, nerves, blood vessels and pigs' salivary glands, in part also separator meat from animal recycling plants).

### OBJECT OF THE INVENTION

It is therefore an object of the present invention to provide a method for the production of sausages, as well as sausages of the initially mentioned type and to further develop this in such a way that the sausages produced with this method have a very low fat content, while at the same time having a juicy and succulent mouth feel and a fresh and meaty taste. On the other hand, the sausages should enjoy high acceptability with the consumer.

According to the present invention, this object is achieved by the features of claim 1 and claim 29.

### ADVANTAGES OF THE INVENTION

In view of the fitness wave in rich industrialized countries, low-fat products are gaining in importance. Low-fat sausages are available on the market in many variations. They usually contain more or less fatty meat from different cuts of beef, pork or poultry. With the well-known low-fat sausage types, the consumer is not able to trace the origin of the animal ingredients. The use of defined carcass portions of an animal for the production of sausages as a sole ingredient of animal origin, has hitherto been unknown.

According to the present invention, pure muscle tissue from the shoulder and/or leg (ham) of pork and in the production of liver sausage additionally pork liver, are the sole animal ingredients used. Otherwise, no other meat and no other animal ingredients, such as rind and skin, lard, offal, separator meat or other carcass parts or milk or egg protein or no other vegetable fats or oils or oil-based fat substitutes are added, the result of which is a very low-fat sausage.

The fat content of the muscle meat is preferably less than 5% by weight, in particular less than 3.5% by weight, relating to the overall mass of the muscle tissue. This can be achieved, if necessary, by partially removing the fat rind from the leg and/or from the shoulder.

In addition, sausages consisting of only a single fraction of pork, apart from their technological properties specific to muscle tissue, they also afford the consumer the greatest possible protection in view of the purity of the product. Ham or shoulder of pork is held in very high esteem by the consumer due to the ham specialties of high quality available on the market, and is regarded as a high-quality food. Ham from the leg or the shoulder is very low in fat after removal of the fat rind (2%-5% fat, measured according to the Soxhlet method), is rich in protein and is therefore appreciated by the consumer as a healthy food.

Sausage types particularly low in fat can be obtained if the muscle tissue used is from the leg (central part, rump or shank). The exclusive use of meat from the central part, from which the outer fat rinds have been removed before production of the sausage, is of particular advantage.

Spices, vegetables and other vegetable ingredients, or even additives can be added as further ingredients, which are known from other food products. It is, however, essential that no vegetable fats or oils or oil-based fat substitutes, such as olestra or salatrim are added.

Sausages produced with the method according to the present invention therefore have a fat content of less than 5 weight %, in particular of less than 3.5 weight %, with respect to the overall mass of the sausage.

To achieve particularly pleasant textural properties, further processing steps are preferably required according to the present invention for the purely pork-based sausages, which will be described in detail in the subsequent description of the exemplary embodiments.

### DESCRIPTION OF EXEMPLARY EMBODIMENTS

### Scalded Sausage

Only lean muscle meat, preferably from the shoulder and/or leg, particularly preferably from the nut of a pig's leg, is processed to produce a scalded sausage according to the present invention. Lean muscle meat should only be meat with a fat content of preferably less than 5 weight %, in particular less than 3.5 weight %, relating to the overall mass of the muscle meat.

During cutter processing, the meat batter must always be well refrigerated, so that the muscle protein does not lose its functionality due to heat degradation. This is done by adding ice or ice water. Methods are also known in the literature wherein liquid nitrogen or dry ice is added for further cooling. However, such expensive auxiliary substances only make the manufacturing process uneconomical.

During cutter processing, the addition of ice means that an energy amount of greater than 120 kJ/kg meat batter, advantageously of greater than 150 kJ/kg, particularly advantageously of greater than 250 kJ/kg meat batter are introduced into the meat batter until a meat batter temperature of 0° C. is reached. Herein, ice is cooled down to a temperature lower than −10° C. (advantageously lower than −20° C., particularly advantageously lower than −40° C.) to achieve substantial protein comminution at very low temperatures. A particularly effective comminution can be achieved when the whole ice amount is added directly at the beginning of cutter processing.

The amount of cooling needed can be achieved either by adding very low temperature ice in a small amount, or by the addition of more ice at less low temperatures. The addition of at least 30 weight %, particularly advantageously of more than 35 weight % ice in relation to the overall meat batter mass is particularly advantageous since a very high percentage of bound water contributes to the succulent and soft mouth feel of the finished sausage.

The addition of ice of a very low temperature is particularly advantageous in that the temperature equalization which takes place freezes at least 20 weight %, particularly advantageously at least 50 weight %, of the water in the meat. A second ice phase is produced thereby. Both ice phases in combination with the shearing forces of the cutter knives enable a particularly high amount of energy to be introduced into the meat batter per time unit, which substantially improves protein comminution.

Surprisingly such processing conditions result in binding 12%, and from the shoulder 8%, more water as gel in the sausage than would be the case, for example, with proteins from other lean muscle groups, such as filet or chop. This is why the provision of sufficient cooling with the use of lean leg or shoulder meat is an ideal combination for the production of low-fat sausages with a high water content and a pleasant mouth feel.

The use of meat from the leg or the shoulder offers further advantages. If it is desired for reasons of texture, the fat rind of the muscle from the leg or shoulder can be at least partially retained to adjust the fat content of the sausage. It has been shown that the fat present on the leg is particularly suitable to be processed with leg muscle protein to achieve an emulsion.

The method of the present invention ensures that a meat batter temperature lower than 0° C. is provided for a long period of time in order to comminute and set free particularly good techno-functional protein sequences. The low temperature control over a long period of time enables the release of valuable protein at the freezing point of the meat from the muscle matrix, thereby comminuting it substantially and enabling excellent water binding and jellification of the proteins. To achieve better texture and to further improve jellification, the temperature is raised to values of not more than 10° C., preferably of not more than 8° C. at the end of cutter processing.

It may be advantageous for improving jellification in individual cases, to let a time period of more than 3 hours, preferably more than 5 hours, elapse until scalding temperature (higher than 60° C.) is reached. It has been shown that water separation during the scalding process is minimized by long periods of intermediate storage before scalding. These advantageous effects of intermediate storage can be improved by raising the meat batter temperature to values above 20° C., advantageously above 35° C. As a result, a substantially firmer structure can be achieved with the same water content.

The present method makes it possible to achieve an extraneous water content of up to 45 weight % in the meat batter without water leaving the sausage after the boiling process.

The advantage of the use of ice as a source of cooling is the relatively low cost as compared with the use of liquid nitrogen or dry ice.

This is how a very pleasant sausage is obtained with a good texture despite the fact that the fat content in the finished sausage has been reduced to values of less than 2.5 weight %. The texture of the product greatly differs from traditional low-fat sausages and when eaten the mouth feel is hard to distinguish from higher fat sausages of the prior art.

In individual cases it may also be advantageous to freeze the meat before introducing it into the cutter to provide further cooling for cutter processing. While this means that the muscle structure is partially lost, it can further lengthen the time of comminution and therefore further homogenize the texture of the meat batter.

A particularly low-fat scalded sausage is achieved if the water content is further increased by the introduction of hydrocolloids. All thickening agents can be used as hydrocolloids as allowed by the LMBG. The addition of hydrocolloids on a carbohydrate basis (e.g. xanthen gum, carob flour) raises the meat batter viscosity to such an extent that it is possible to introduce up to 50 weight % extraneous water into the sausage.

The addition of more extraneous water makes it possible to add more ice in the process, so that the meat batter can be cutter processed for a particularly long time and the muscle protein is comminuted to a particularly high degree. It may be advantageous to dissolve the hydrocolloids in water, to freeze the solution and to add it together with the ice to the cutter. This is how the cutter processing time (and therefore the comminution time of the structure bound protein fraction) can be maximized.

In a particularly advantageous embodiment, vegetable protein is added to the meat batter in order to further enhance the gel firmness of the sausage. Particularly advantageous is the addition of up to 3 weight % of leguminous protein (e.g. from pea, soy bean, lupin, horse bean). The use of other vegetable proteins is also possible. The addition of vegetable proteins is particularly advantageous in the form of a deep-frozen protein solution. Well dissolved protein is therefore available for processing. Also, additional coldness is introduced into the system by the protein solution being in frozen form.

It is advantageous to grind the meat before cutter processing and to freeze it to values of less than 0° C., wherein more than 10% of freezable water present in the meat is to be frozen. It is also advantageous to cool the cutter in advance of and/or during the meat batter production to values lower than 5° 6, advantageously lower than 1° C.

A particularly simple and economical process is achieved if the muscle groups used are not ground by grinding prior to cutter processing. The large amount of added ice quickly comminutes meat chunks of a diameter greater than 5 cm.

The geometry and speeds of cutter knives are of critical importance in the production of the meat batter for sausages. Herein, the shearing rate is the critical parameter, which can be derived from the orbital velocity of the cutter knife and the gap width between the knife and the cutter bowl. With shearing rates above 25.000 l/s, the meat batter properties are improved by an improved protein comminution. Above 60.000 l/s, however, the meat batter properties are degraded due to an increased protein degradation due to partial temperature peaks. There is therefore an optimum shearing rate for protein comminution between 50.000 and 60.000 l/s. The use of special cutter knives blunted for protein comminution, leads to a particularly uniform comminution.

The shearing rates given above can be achieved by cutters, but also by other industrial meat comminuting machines, such as colloid mills.

A basic meat batter is created with the above described method, from which various types of sausage, such as ham sausage, luncheon meats with different ingredients (pistachios, mushrooms, herbs, vegetables), Göttinger, Frankfurter, Bratwurst, meat loaf (or spam) or pates (or pastes) are produced in further processing steps.

The firm structure of the scalded sausage can be reinforced by the addition of fibre products. Commercially available fibre products, made of wheat, leguminosae or oat are suitable.

According to a particular embodiment of the method, the scalding process is carried out at heating and cooling rates of less than 5 K/min.

Bioactive sausage products can also be obtained, when secondary vegetable ingredients, such as lignanes, pytosteroles, poyphenoles or isoflavanoides are added.

### Cooked Sausage

Cooked sausages having a very low fat content, such as liver sausages or liver pates, can be produced of leg and shoulder of pork.

Muscle meat from the leg or shoulder of pork, preferably from the leg, particularly preferably from the central portion of the leg and pig's liver, in pure form, with the fat rind essentially removed, is the sole animal ingredient used for cooked sausages or cooked meat spread. No other fat, such as lard or oil or an oil-based fat substitute component is added apart from the fat contained in the muscle meat and the liver.

The fat content in the muscle meat is no more than 5 weight %, preferably no more than 3.5 weight %, and in pig's liver no more than 6 weight %. The use of fresh pig's liver with the bile ducts removed is particularly advantageous.

Surprisingly it has been shown that a particularly creamy cooked sausage can be obtained if the meat is not cooked before cutter processing but is scalded at temperatures below 85° C., advantageously below 75° C. By this the proteins are only partially denaturated and a succulent sausage structure is obtained.

The preferred temperature for cutter processing of the cooked sausage meat batter of fresh liver and boiled meat is higher than 40° C., preferably higher than 50° C. The liver is particularly well comminuted by this, and a firm and creamy structure is achieved.

In one advantageous embodiment of the method according to the present invention, meat and liver are dry cutter processed at the beginning of cutter processing and the remaining ingredients and water or brine from the scalding process of the meat is only added shortly before the end of cutter processing. To achieve better comminution, comparable shearing rates are chosen as for the production of scalded sausage meat batter. This manner of processing makes it possible to avoid the addition of emulsion agents as additives.

The creaminess of the sausage can be improved if up to 3% hydrocolloids on the basis of carbohydrates are added during production in the cutter. Particular advantages result from the use of Xanthen gum in weight % of 0.5-1% in relation to the overall mass.

The creaminess of the sausage can also be improved if up to 4 weight % with relation to the overall sausage mass, vegetable protein is added during production in the cutter. Particularly advantageous characteristics can be obtained if leguminous proteins, such as lupine proteins or oil seed proteins, such as sunflower proteins are used. After the addition of 3% lupine protein in the cutter, cooked sausages become easy to spread and very creamy despite the low fat content of less than 3%. The result is particularly good, if a micelle-precipitated lupine protein isolate is used as a protein. If the heating temperature of the cooked sausages filled in casings or jars is kept below 75° C., spreading properties are also particularly good, since the vegetable proteins are not completely denaturated. The use of wet vegetable proteins or frozen aqueous protein solutions offers particular advantages, since the protein solubility is particularly high.

The firm structure of the cooked sausage can be reinforced by the addition of fibre products. Commercially available fibre products, such as wheat, leguminosae or oat are suitable.

A creamy structure is achieved if the heating temperature of the filled meat batter is just below the denaturing temperature of the vegetable proteins, but above the denaturing temperature of liver, and above the required pasteurizing temperature.

According to a particular embodiment of the method for producing liver sausage, the scalding process is carried out at heating and cooling rates of less than 5 K/min.

Bioactive sausage products can be obtained if secondary vegetable ingredients such as lignanes, pytosteroles, polyphenoles or isoflavanoides are added.

### Raw Sausage

Raw sausages having a very low fat content and a particularly native protein structure can be produced of leg and shoulder of pork.

To produce raw sausages, pure muscle meat from the leg or the shoulder of pork, advantageously the leg, with the fat rind essentially removed is used as the sole animal ingredient, with no further fat such as lard or oil or an oil-based fat substitute added apart from the fat contained in the muscle meat. The fat content in the muscle meat is no more than 5 weight %, preferably no more than 3.5 weight %.

The raw sausage of such lean meat obtains a structure similar to ham or cured tenderloin, that can be varied much more widely in taste and texture by mixing in various ingredients.

Surprisingly it has been shown that a low-fat raw sausage having a particularly firm, ham-like texture can be obtained, if the meat mass is not frozen, or not frozen by more than 50%, of the maximum freezable water content before cutter processing.

It is also advantageous if the meat is added at temperatures of below 5° C., particularly advantageously below 1° C., but not frozen, i.e. not below −2° C.

In a particularly advantageous embodiment of the method according to the present invention, a portion of the meat mass, preferably 50%, is ground through a plate with a hole diameter of less than 4 mm. The other portion is pre-ground through a plate having a hole diameter of more than 7 mm.

The ground portion of the meat mass is cutter processed to a binding stage in the cutter at a temperature of more than 12° C., preferably more than 14° C. After 90% of cutter processing time, preferably after completion of the cutter processing time for the ground portion, starter cultures, spices, salt and/or nitrite pickling salt, and the pre-ground portion of the meat are added and mixed in.

In another embodiment, hydrocolloids on the basis of carbohydrates, such as xanthen gum and/or fibre product, such as wheat fibre or leguminosae fibre are added. The addition of these additives can accelerate the maturing process and regulate the binding of water. Vegetable protein products can also be added. Secondary vegetable ingredients, such as lignanes or phytosteroles can also be added. Vegetables, such as pepperoni or horseradish, may also be included. Finally, the filled-in sausage mass can be smoked.

We claim:

1. A method for producing sausage products, the sausage products including one or more of raw sausages, scalded sausages and cooked sausages, the method steps comprising:
providing muscle meat from at least one of the leg and shoulder of pork, the muscle meat including a fat content of no more than 5% by weight as related to the overall mass of the muscle meat, and
wherein no further fat content is provided.

2. The method according to claim 1, wherein the muscle meat is from a central portion of the leg.

3. The method according to wherein the method steps further comprise providing, pig's liver with the bile ducts removed.

4. The method according to claim 1, wherein the fat content in the muscle meat is no more than 3.5% by weight.

5. The method according to claim 1, wherein the method steps further comprise providing at least one of spices, salt, nitrite pickling salt, mushrooms, vegetables and brine.

6. The method according to claim 1, wherein the sausage products are the scalded sausages and the muscle meat is processed to a meat batter together with an amount of ice.

7. The method according to claim 6, further providing the amount of ice such that an energy amount of greater than 120 kJ/kg of meat batter to achieve a meat batter temperature of 0° C. is introduced in the meat batter.

8. The method according to claim 7, wherein the entire amount of ice is added at the beginning of the meat batter production and has a temperature of less than −10° C.

9. The method according to claim 8, wherein the amount of ice that is added to the muscle meat is such that at least 20% by weight of the water contained in the muscle meat is frozen.

10. The method according to claim 8, wherein the amount of ice that is added to the muscle meat is such that the ice is at least 30% weight of the overall mass of the meat batter.

11. The method according to claim 6, wherein the muscle meat is processed to meat batter at least in a partially frozen state.

12. The method according to claim 6, wherein thickening agents are also added in the meat batter.

13. The method according to claim 12, wherein vegetable proteins are also added in the meat batter.

14. The method according to claim 6, wherein the meat batter production is carried out in one of a cutter and a meat comminuting apparatus.

15. The method according to claim 14, wherein the cutter processing is carried out at a shearing rate in a range between 25,000/s and 60,000/s.

16. The method according to claim 6, wherein the meat batter has a temperature of no more than 10° C. at an end of the meat batter production.

17. The method according to claim 6, wherein the meat batter is scalded at a temperature in a temperature range between 60° C. and 80° C.

18. The method according to claim 6, wherein the sausage products are the cooled sausages and the muscle meat is scalded at a temperature of less than 85° C. before the muscle meat is processed to a meat batter together with pig's liver.

19. The method according to claim 18, wherein the temperature of the meat batter is more than 40° C. during meat batter production.

20. The method according to claim 18, wherein no more than 3% by weight of hydrocolloids are added to the meat batter.

21. The method according to claim 18, wherein no more than 4% by weight of vegetable protein is added to the meat batter.

22. The method according to claim 18, wherein fibre-containing substances are added to the meat batter.

23. The method according to claim 18, wherein the meat batter is heated to a scalding temperature of less than 75° C.

24. The method according to claim 18, wherein the scalding is carried out at a heating and cooling rate of less than 5 K/min.

25. The method according to claim 1, wherein the sausage products are the raw sausage and the muscle meat is processed to a meat batter in an initial state in which no more than 50% of the water contained in the muscle meat is frozen.

26. The method according to claim 25, wherein the temperature of the muscle meat at a beginning of a meat batter production is in a range between −2° C. and 5° C.

27. The method according to claim 25, wherein a portion of the muscle meat is ground and the rest is a pre-ground portion.

28. The method according to claim 27, wherein the ground portion of the muscle meat is cutter processed until a binding stage is reached and after completion of the cutter processing time of the ground portion, one or more of starter cultures, spices, salt, nitrite pickling salt, and the pre-ground portion of the muscle meat is added and mixed in.

29. A sausage product, the sausage product including one or more of raw sausages, scaled sausages and cooked sausages, the sausage product comprising:
muscle meat of pork, the muscle meat having a fat content of no more than 5% by weight as related to the overall mass of the muscle meat;
wherein no further fat is included and the muscle meat is the sole animal ingredient.

30. The sausage product according to claim 29, wherein the muscle meat is from one of the leg and shoulder of pork.

31. The sausage product according to claim 29, wherein the fat content is no more than 3.5% by weight.

32. The sausage product according to claim 3, wherein the pig's liver includes a fat content of no more than 6% by weight.

33. The sausage product according to claim 29, further comprising pig's liver.

34. The sausage product according to claim 33, wherein the pig's liver includes a fat content of no more than 5% by weight.
